(19) United States
(12) Patent Application Publication
(10) Pub. No.: US 2005/0258567 A1
(43) Pub. Date: Nov. 24, 2005

(54) Completely degradable paper-like material with starch as basic material and its preparation

(76) Inventor: Huiqun Wang, Guangdong (CN)

Correspondence Address: SHELDON & MAK, INC, 225 SOUTH LAKE AVENUE, 9TH FLOOR, PASADENA, CA, 91101, US

(21) Appl. No.: 11/118,226

(22) Filed: Apr. 28, 2005

(30) Foreign Application Priority Data
Oct. 28, 2002 (CN) CN 02130898.5

(51) Int. Cl. B29C 47/60

(52) U.S. Cl. 264/211.23; 264/349; 162/158; 162/175

(57) ABSTRACT

A completely degradable paper-like material with a starch base. A method of making a completely degradable paper-like material with a starch base.

### BACKGROUND OF THE INVENTION

1. Technical Field

The present invention relates to a composition comprising starch, amylose or amylopectin, or a derivative or a degradation product thereof, and the preparation of a film or a sheet containing macromolecule substances, and particularly to a completely degradable paper-like material with a starch base and a method for the preparation thereof.

2. Technical Background

Plastics now commercially available in the packaging industry are not self-degradable, and when discarded, can cause severe pollution to the environment of human and other animals, and plants. The degradation period of petroleum chemical plastics can be shortened by adding therein a naturally degradable macromolecule such as starch, but this kind of plastics can only be broken down into pieces. Currently, there are no plastics that are completely degradable. There have been containers made from paper prepared from completely degradable natural cellulose materials. However, the containers have the disadvantages of being poorly waterproof and poorly oil resistant, have a high cost and low strength, which consequently limits their applications. Moreover, the pollution caused by the manufacturing of these paper products is several or tens of times more than that caused by the manufacturing of plastic products.

### SUMMARY OF THE INVENTION

To overcome the defects of the prior art, the present invention provides a completely degradable paper-like material with a starch base and a process of preparing the same. One embodiment of the invention is presented as follows.

An example of a product of the completely degradable paper-like material with a starch base has a thickness of 0.25-2.50 millimeters, and comprises the following components by weight:
starch 52.8-76.92%;
poly(propylene-ethylene) 10.07-24.60%;
polyethylene 2.42-10.17%;
a nucleating agent 0.63-3.54%;
a nucleating agent capable of improving the transparency of an article 0.08-0.60%;
a durable plasticizer 0.23-1.79%;
a weatherproof plasticizer (i.e., antifreeze agent) 1.55-4.17%;
an antioxidant 0.38-1.80%;
a stabilizer 0.39-2.38%;
a waterproofing agent 0.78-2.63%;
a hygroscopic agent 0.77-2.40%;
a lubricant 0.78-2.98%; and
a demolding agent 0.23-1.79%.

In one embodiment of the invention, the completely degradable paper-like material with a starch base also has the following features:

The starch used in the material is selected from the group consisting of corn starch, potato starch, and rice/wheat starch;
the nucleating agent can be urea, i.e., carbamide, or ε-caprolactam;
the nucleating agent capable of improving the transparency of the article is substituted bis(phenyl methylene) sorbitol;
the durable plasticizer is a polyester plasticizer;
the weatherproof plasticizer (i.e., antifreeze agent) can be epoxidized soybean oil, glycerol or complex glycerol;
the antioxidant can be 2,2-methylene-bis(4-methyl-6-tert-butyl phenol), i.e., antioxidant 2246, or tris(2,4-di-tert-butyl phenyl) phosphite, i.e., antioxidant 168, or pentaerythritol tetra[β-(3,5-di-tert-butyl-4-hydroxy) phenylpropionate], i.e., antioxidant 1010;
the stabilizer and the hygroscopic agent used in the invention can be zinc stearate and calcium stearate, or calcium stearate and zinc stearate, respectively;
the waterproofing agent can be microcrystalline wax or olefin;
the lubricant is talc; and
the demolding agent is stearic acid.

In one embodiment, the present invention is a method for preparing a completely degradable paper-like material with a starch base comprising successively the following steps:
(1) adding starch, poly(propylene-ethylene) and polyethylene to a high-speed mixer and the resultant mixture being mixed for 1-2 minutes at 80-120 rpm and a temperature of 95-120° C.;
(2) adding a nucleating agent, a nucleating agent capable of improving the transparency of an article, a durable plasticizer, a weatherproof plasticizer, an antioxidant, a stabilizer, a waterproofing agent, a hygroscopic agent, a lubricant and a demolding agent to the high-speed mixer to mix at 700-860 rpm for 25-35 minutes;
(3) charging the resultant mixture into a cooling mixer and cooling at 50-100 rpm for 5-10 minutes;
(4) discharging the resulted mixture to obtain a desired powdery crude material; and
(5) charging the powdery crude material into an extrusion molding equipment for preparing a completely degradable paper-like material, which consists of a twin-screw extruder, a coat-hanger head die with a booster joint part connected to a barrel, a 3-roll laboratory calender, an edge-trimming unit, a cooling unit, a towing machine and a convolving machine, and preparing the completely degradable paper-like material with a starch base, in which a rotational speed of the screws of the extruder is 300-400 rpm, and a temperature inside each of the functional portions of the equipment is set separately ranging from 140-185° C., and this step comprises successively transporting and milling, shearing and plasticizing, dehydrating and exhausting, pressurizing and extruding, calendering and edge-trimming, cooling and towing, and convolving the final product.

The material of the present invention contains a highly biodegradable macromolecule, starch, as a primary component, which is combined with a biodegradable polymer and milled at a specific temperature and pressure. Then, to the mixture are added a nucleating agent, a plasticizer, an antioxidant, a stabilizer, a waterproofing agent, a hygroscopic agent, a lubricant and a demolding agent to physically and chemically modify. Consequently, the material of the present invention has improved heat-resistance, and is highly waterproof, oil resistance, leakage-resistant, has increased impact resistance, and is resistant to deformation, flexing and the like. As a result, the material of the invention can be eroded, absorbed, degraded, worn-out and disabled in a bio-environment. That is, the material of the invention can be completely degraded, which is the object of the invention.

In comparison with the prior art, the invention has the advantages of an optimal formulation, and a simple preparation process with a low cost. In particular, the material of the invention is advantageous as it is nontoxic, pollution-free and completely biodegradable, can be used after being discarded as a compost or a culturing component for cultivating edible fungus, such as mushroom and other soil-less cultures, and leaves nothing but white ashes after incineration. The paper-like material of the invention has an excellent heat-resistance, is highly waterproof and oil resistant, and can be prepared by a hot-pressing process, and used in producing various disposable packaging containers, especially food containers, or other articles. The paper-like material of the invention is also highly weatherproof and suitable for printing, and can be used as a printing carrier bearing various disposable graph information, especially advertisements.

### PREFERRED EMBODIMENTS OF THE INVENTION

In one embodiment of the invention, there is provided a completely degradable paper-like material that includes corn starch as a primary component thereof. By example, a product made of the paper-like material of the present invention has 0.50 millimeters in thickness, and consists of the following components (by weight): corn starch 62%, poly(propylene-ethylene) 20%, polyethylene 7%, carbamide 1.8%, substituted bis(phenyl methylene) sorbitol (i.e., nucleating agent TM-3) 0.2%, epoxidized soybean oil 2.5%, polyester plasticizer 0.65%, antioxidant 2246 {i.e., 2,2-methylene-bis(4-methyl-6-tert-butyl phenol)} 0.5%, zinc stearate 0.7%, microcrystalline wax 1.5%, calcium stearate 1.3%, talc 1.0%, and stearic acid 0.85%.

In one embodiment of the present invention, there is provided a method for preparing a completely degradable paper-like material with a starch base comprising the following steps:
a) adding corn starch, poly(propylene-ethylene) and polyethylene to a high-speed mixer, and mixing the resultant mixture for 2 minutes at 100 rpm at a temperature of 110° C.;
b) adding a nucleating agent, a nucleating agent capable of improving the transparency of an article, a durable plasticizer, a weatherproof plasticizer, an antioxidant, a stabilizer, a waterproofing agent, a hygroscopic agent, a lubricant and a demolding agent to the high-speed mixer to mix at 800 rpm for 30 minutes;
c) charging the resultant mixture into a cooling mixer and cooling at 80 rpm for 8 minutes;
d) discharging the resulted mixture to obtain a desired powdery crude material; and
e) feeding the powdery crude material into an extrusion molding equipment for preparing a completely degradable paper-like material, which consists of a twin-screw extruder, a coat-hanger head die with a booster joint part connected to a barrel, a 3-roll laboratory calender, an edge-trimming unit, a cooling unit, a towing machine and a convolving machine, and preparing the completely degradable paper-like material with a starch base, in which a rotational speed of the screws of the extruder is 360 rpm, and a temperature inside each of the functional portions of the equipment is set separately ranging from 140-185° C., and this step comprises successively transporting and milling, shearing and plasticizing, dehydrating and exhausting, pressurizing and extruding, calendering and edge-trimming, cooling and towing, and convolving the final product.

When fabricated into disposable dishware, the paper-like material of the invention has a good appearance, and can tolerate a temperature between 100° C. and −18° C. Additionally, it has a better degradability than current paper and fiber dishware, and therefore it can be used to replace currently used materials for packaging instant food.

Although the present invention has been discussed in considerable detail with reference to certain preferred embodiments, other embodiments are possible. Therefore, the scope of the appended claims should not be limited to the description of preferred embodiments contained in this disclosure. All references cited herein are incorporated by reference to their entirety.

1. A degradable paper-like material with a starch base, comprising the following components by weight:
starch 52.8-76.92%;
polypropylene 10.07-24.60%;
polyethylene 2.42-10.17%;
a nucleating agent 0.63-3.54%;
a nucleating agent capable of improving the transparency of the article 0.08-0.60%;
a durable plasticizer 0.23-1.79%;
a weatherproof plasticizer (i.e., antifreeze agent) 1.55-4.17%;
an antioxidant 0.38-1.80%;
a stabilizer 0.39-2.38%;
a waterproofing agent 0.78-2.63%;
a hygroscopic agent 0.77-2.40%;
a lubricant 0.78-2.98%; and
a demolding agent 0.23-1.79%.

2. The degradable paper-like material of claim 1, wherein the starch is selected from the group consisting of corn starch, potato starch and rice/wheat starch.

3. The degradable paper-like material of claim 1, wherein the nucleating agent is carbamide or ε-caprolactam.

4. The degradable paper-like material of claim 1, wherein the nucleating agent capable of improving the transparency of the article is substituted bis(phenyl methylene) sorbitol.

5. The degradable paper-like material of claim 1, wherein the durable plasticizer is a polyester plasticizer.

6. The degradable paper-like material of claim 1, wherein the weatherproof plasticizer is epoxidized soybean oil, glycerol or complex glycerol.

7. The degradable paper-like material of claim 1, wherein the antioxidant is 2,2-methylene-bis(4-methyl-6-tert-butyl phenol), tris(2,4-di-tert-butyl phenyl) phosphite, or pentaerythritol tetra[β-(3,5-di-tert-butyl-4-hydroxy) phenylpropionate].

8. The degradable paper-like material of claim 1, wherein the stabilizer and the hygroscopic agent are zinc stearate and calcium stearate, or calcium stearate and zinc stearate, respectively.

9. The degradable paper-like material of claim 1, wherein the waterproofing agent is microcrystalline wax or olefin.

10. The degradable paper-like material of claim 1, wherein the lubricant is talc.

11. The degradable paper-like material of claim 1, wherein the demolding agent is stearic acid.

12. A method for preparing a completely degradable paper-like material with a starch base, comprising the following steps:
a) adding corn starch, polypropylene and polyethylene to a high-speed mixer, the resultant mixture being mixed at 100 rpm and 110° C. for 2 minutes;
b) adding a nucleating agent, a nucleating agent capable of improving the transparency of an article, a durable plasticizer, a weatherproof plasticizer, an antioxidant, a stabilizer, a waterproofing agent, a hygroscopic agent, a lubricant and a demoulding agent to the high-speed mixer to mix at 800 rpm for 30 minutes;
c) charging the resultant mixture into a cooling mixer and cooling at 80 rpm for 8 minutes;
d) discharging the resulted mixture to obtain a desired powdery crude material; and
e) feeding the powdery crude material into an extrusion moulding equipment for preparing a completely degradable paper-like material, which consists of a twin-screw extruder, a coat-hanger head die with a booster joint part connected to a barrel, a 3-roll laboratory calender, an edge-trimming unit, a cooling unit, a towing machine and a convolving machine, and preparing the completely degradable paper-like material with a starch base, in which a rotational speed of the screws of the extruder is at 360 rpm, and a temperature inside each of the functional portions of the equipment is set separately ranging from 140-185° C., and this step comprises successively transporting and milling, shearing and plasticizing, dehydrating and exhausting, pressurizing and extruding, calendering and edge-trimming, cooling and towing, and convolving the final product.
